(19) United States
(12) Patent Application Publication
(10) Pub. No.: US 2011/0099074 A1
(43) Pub. Date: Apr. 28, 2011

(54) System and Method for Providing Marketing Offers to Users of Financial Account Issuer Website

(75) Inventor: Uday Oak, San Ramon, CA (US)

(73) Assignee: Visa U.S.A. Inc.

(21) Appl. No.: 12/891,923

(22) Filed: Sep. 28, 2010

Related U.S. Application Data
(60) Provisional application No. 61/255,374, filed on Oct. 27, 2009.

(51) Int. Cl. G06Q 30/00

(52) U.S. Cl. 705/14.66

(57) ABSTRACT

A system for providing a marketing offer to holders of financial accounts during a communication session with the financial account issuer includes a processor and an account maintenance module executable by the processor. The account maintenance module initiates a communication session with a user computer of an account holder over a computer network. Before the communication session ends, the account maintenance module determines whether the account holder's a financial account is a target for receiving the marketing offer and if so, transmits the marketing offer to the user computer over the computer network.

### CROSS REFERENCE TO RELATED APPLICATIONS

This application claims the benefit of U.S. Provisional Application No. 61/255,374, filed Oct. 27, 2009, which is incorporated by reference herein.

### FIELD OF THE INVENTION

The present invention relates to data processing, and in particular relates to a method and system for providing marketing offer information to a holder of a financial account.

### BACKGROUND OF THE INVENTION

A transaction processor such as Visa® includes a computer network that acts as a switch between acquirers and issuers for routing their messages for purposes of authorization, clearing and/or settlement of financial transactions originating from merchants. In addition to processing transactions, the transaction processor may also provide a direct mail campaign on behalf of merchants and issuers whereby a marketing offer is mailed to a selected target group of financial account holders. For example, Visa provides a program called Visa Incentive Network, which is a full-service direct marketing program in which a marketing offer from a participating merchant is mailed to a targeted group of card holders from participating issuers. The cardholders are specifically targeted according to preselected criteria.

Even though the offers are targeted, many card holders simply throw them away. Moreover, the mailing cost of each marketing offer makes it very expensive to implement.

Therefore, it would be desirable to provide a system and method for providing marketing campaigns that are more effective and yet less expensive.

### SUMMARY OF THE DISCLOSURE

According to one aspect of the invention, a system for providing a marketing offer to holders of financial accounts during a communication session with the financial account issuer is provided. The system includes a processor such as a central processing unit and an account maintenance module executable by the processor. The account maintenance module initiates a communication session with a user computer of an account holder over a computer network. Typically during the communication session with the issuer, the account holder performs account maintenance such as checking on account activity, making payments to the issuer and changing personal profile data.

Before the communication session ends, the account maintenance module determines whether the account holder's financial account is a target for receiving the marketing offer and if so, transmits the marketing offer to the user computer over the computer network. As persons of ordinary skill in the art will readily appreciate, among many advantages, one advantage of displaying the targeted marketing offer on the user computer while the account holder is in a communication session is that it avoids the high cost of mailing the offers. Another advantage is that the targeted offer is much more likely to be viewed by the account holder rather than ignored if sent by mail.

According to another aspect of the invention, a system for providing a marketing offer to holders of financial accounts during a communication session is provided. The system includes a processor and an offer management module executable by the processor. The offer management module communicates with an issuer computer that initiates a communication session with a user computer of an account holder. The offer management module (1) receives from the issuer computer a message containing the account holder's financial account identifier before the communication session ends, (2) in response to the received message, determines whether the associated financial account is a target for receiving the marketing offer, and (3) if so, transmits a message to the issuer computer that the associated financial account is a target for receiving the marketing offer.

According to another aspect of the invention, a system for providing a marketing offer to holders of financial accounts during a communication session is provided. The system includes an issuer computer, a target database and an offer management computer coupled to the issuer computer and the target database. The issuer computer initiates a communication session with a user computer of an account holder over a computer network when, for example, the account holder logs in to the issuer computer. The target database stores financial account identifiers identifying financial accounts that have been targeted for receiving a marketing offer which is available to a plurality of issuers of financial accounts. In other words, the same marketing offer is available to multiple issuers.

The offer management computer receives from the issuer computer a message containing an account identifier identifying a financial account associated with the holder before the communication session ends. In response to the received message, the offer management computer queries the target database to determine whether the associated financial account is a target for receiving the marketing offer and if so, transmits a message to the issuer computer that the associated financial account is a target for receiving the marketing offer.

According to another aspect of the invention, a method by an issuer computer of providing a marketing offer to holders of financial accounts during a communication session is provided. The method includes (1) interacting, by the issuer computer, with a user computer of an account holder to initiate a communication session, (2) determining, before the communication session ends, whether a financial account associated with the holder is a target for receiving the marketing offer, and (3) if so, transmitting, by the issuer computer, the marketing offer to the user computer.

According to another aspect of the invention, a method by an offer management computer of providing a marketing offer to holders of financial accounts during a communication session is provided. The method includes (1) receiving by the offer management computer a message from an issuer computer that has initiated a communication session with a user computer of an account holder, the message being received before the communication session ends and containing an account identifier identifying a financial account associated with the holder, (2) in response to the received message, determining by the offer management computer whether the associated financial account is a target for receiving the marketing offer, and (3) if so, transmitting a message to the issuer computer that the associated financial account is a target for receiving the marketing offer.

### BRIEF DESCRIPTION OF THE DRAWINGS

FIG. 1 is a diagram of a system for offering targeted marketing offers to users of issuer websites according to one embodiment of the invention.

FIG. 2 is a functional block diagram of a computer that can be used by any entity shown in FIG. 1.

FIG. 3A is a process flow diagram of interactions among a user computer, issuer computer and offer management computer according to an embodiment of the invention.

FIG. 3B is a detailed process flow diagram for the offer management computer to assemble a reply message.

FIG. 4 is an exemplary image of a targeted marketing offer.

### DETAILED DESCRIPTION OF THE INVENTION

For purposes of illustration and clarity, the present invention will be discussed in the context of using a credit card having an account number. However, persons of ordinary skill in the art will appreciate that the novel features disclosed herein apply to all types of financial accounts including, but not limited to, checking and savings accounts, Internet accounts, credit cards, debit cards, prepaid cards, electronic benefit cards, charge cards, smart cards, key chain devices, personal digital assistants, cell phones, stored value devices or the like so long as the account identifying information can be presented to a seller of goods or services for payment.

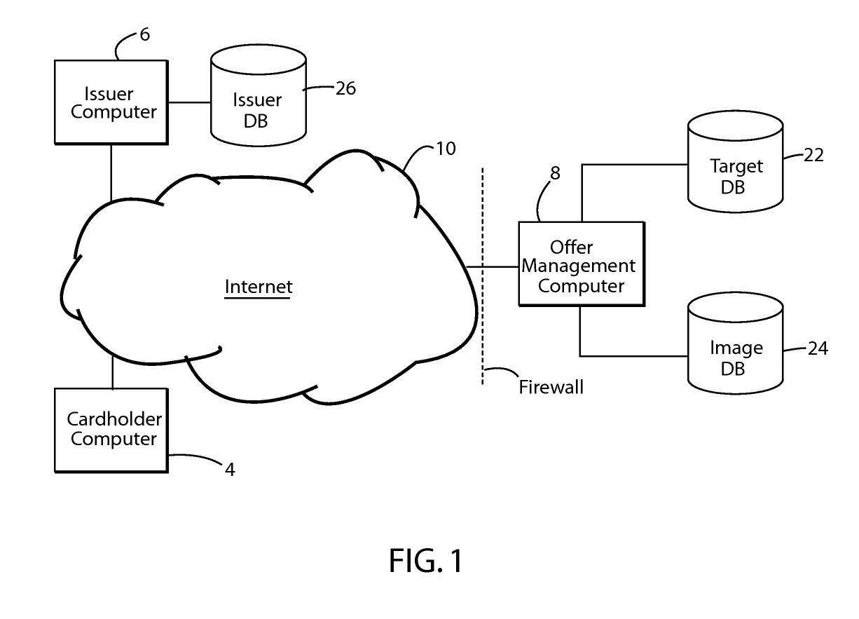

Briefly, according to one aspect of the invention as illustrated in FIG. 1, instead of physically mailing out merchant offers (offers from a direct mail campaign), the offers are displayed on the cardholders' computers 4 when they log in to the websites of their issuers 6. In operation, a transaction processor such as Visa 8 maintains in a target database 22 a list of card account numbers from multiple issuers that are participating in the merchant offer as well as electronic images of the marketing offers in an image database 24. When a cardholder logs in to his issuer's website 6, the issuer transmits the account number to Visa 8. Visa 8 checks the number against its target database 22. If the number is present, Visa 8 sends a message to the issuer 6 that the cardholder has been targeted to receive a particular marketing offer. Based on the message, the issuer 6 transmits to the cardholder's web browser the marketing offer image to the cardholder's computer 4 for display while the cardholder is in a communication session with the issuer's website.

In one embodiment, the issuer transmits to the cardholder's web browser a web page containing an instruction to download an image of the marketing offer from an image location which points to a file name path residing in a server of Visa. The web browser then downloads the marketing offer image to the cardholder's computer for display. This way, a transaction processor such as Visa can provide the same benefits of targeted marketing of offers while saving substantial amount of money in postage and printing fees.

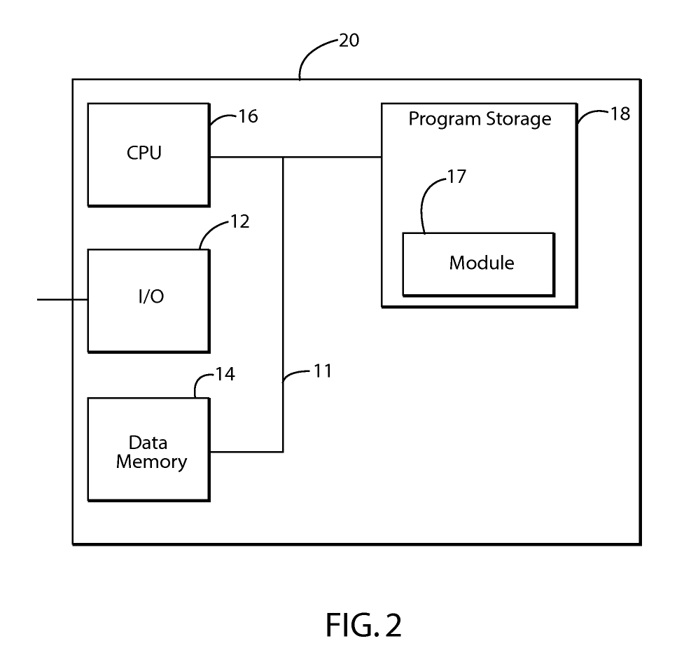

FIG. 2 illustrates a computer system 20 that can be used by a card holder computer 4, merchant computer, issuer computer 6 or offer management computer 8. The offer management computer may be a separate computer or a part of the transaction processing computer system that routes messages for purposes of authorization, clearing and/or settlement of financial transactions originating from merchants.

The system 20 includes a communication interface 12, a processor (CPU) 16, a memory 14, 18 coupled to the processor, and software or software modules 17 executable by the processor. The elements 12,14,16,18 are all connected to each other through a common bus 11.

FIG. 1 is a diagram of a system for offering marketing offers to users of issuer websites while FIG. 2 is a flow chart of a method of offering marketing offers to users of issuer websites wherein the steps in the first, second and third columns refer to those performed by a cardholder's computer 4, issuer computer 6, and offer management computer 8, respectively.

Steps 32 and 48 are typically performed by a web browser module of the cardholder. Steps 34-38 and 46 are performed by an account maintenance module which is executed by a processor of the issuer computer 6. Steps 40-44 are performed by an offer management module which is executed by the offer management computer 8.

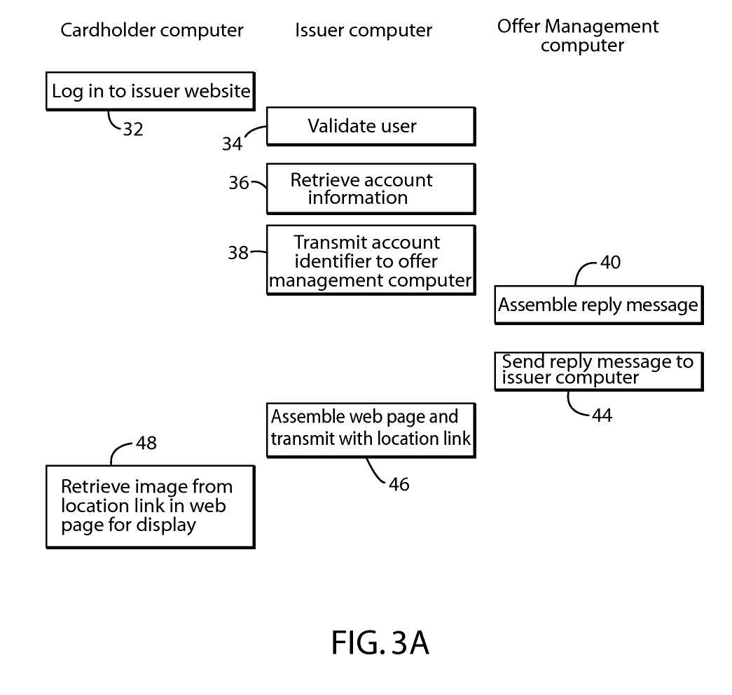

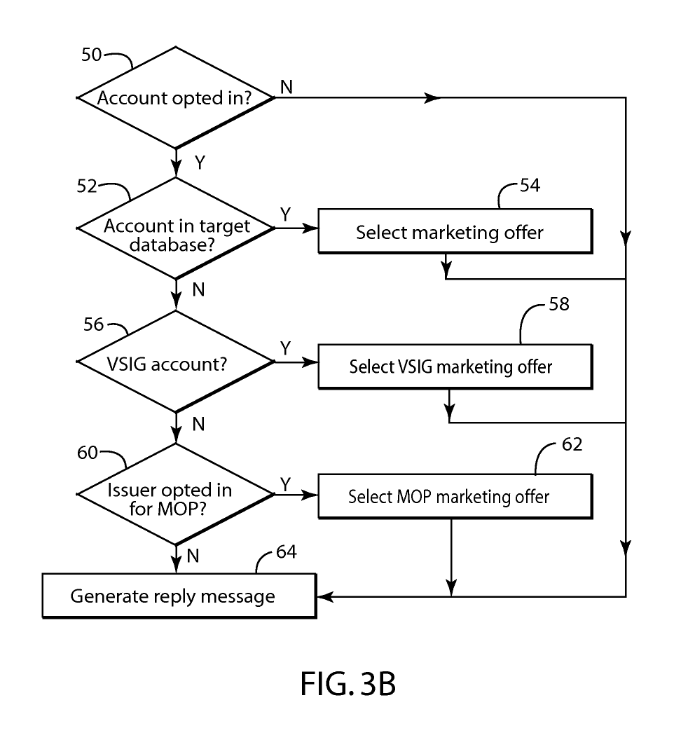

The present invention generally takes advantage of the fact that many cardholders have set up a web login to their own issuer banks to perform account maintenance such as checking on account activity, making payments to the issuer and changing personal profile data. Referring to both FIGS. 1 and 3, in step 32, a cardholder, through its computer 4 web browser, logs in to an issuer's computer 6 through the Internet 10 to initiate a communication session. Typically this involves submitting a user id and password. In step 34, the issuer computer 6 checks the received user id and password in an issuer database 26 and validates the user. In one embodiment, if the user has been validated, the issuer computer 6 starts the communication session which lasts until the user logs out or closes the browser program. In step 36, once validated, the issuer 6 retrieves account information from the issuer database 26 including an account identifier such as the 16 digit card number of the financial account belonging to the cardholder/user. In step 38, the issuer 6 transmits a message containing the retrieved account identifier to the offer management computer 8 through a computer network such as the Internet 10. The offer management computer 8 is behind a fire wall to prevent access from unauthorized entities or users. The message requests the offer management computer 8 to check whether the account identified by the account identifier has been targeted for any specific merchant marketing offer.

In step 40, an offer management module being executed by the processor of the offer management computer 8 assembles/generates a reply message in response to the message received from the issuer computer 6. Step 40 comprises steps 50-64 which are illustrated in FIG. 3B in more detail.

Referring to FIG. 3B, in step 50, the offer management module determines whether the financial account identified by the account identifier contained in the received message has opted in to receive marketing materials from an issuer of the financial account. To do so, the management module queries the target database 22 with the received account identifier. The target database 22 contains a set of records with each record identifying a targeted account number and containing a flag indicating whether the holder of the account has opted in to receiving marketing offers.

Each record also may contain a “web id available” flag that indicates whether the holder of the financial account has set up a web login on the issuer's website computer 6. The offer management module then determines whether (1) the “web id available” indicates that the holder has set up the web login and (2) the associated flag indicates that the holder of the account has opted in to receive marketing offers.

The account numbers of cardholders and their associated flags can be retrieved, for storage in the target database 22, from the CMF (card maintenance file) that the offer management module receives from each issuer on a regular basis. The CMF already contains cardholder name, cardholder address, account number, Product ID (e.g., Visa Signature, Visa Signature Preferred, etc.), Opt-in flag, and rewards ID (code number issued by the offer management computer 8 to identify the reward portfolio). The CMF also has unused fields that can be used by the issuers to insert the “web id available” flag.

The identification of a specific marketing offer can be determined by selection criteria for each marketing offer, which can be provided by a merchant, issuer or the transaction processor itself. For example, accounts can be targeted by an electronic goods merchant by the cardholder's propensity to purchase similar goods from the past purchase history.

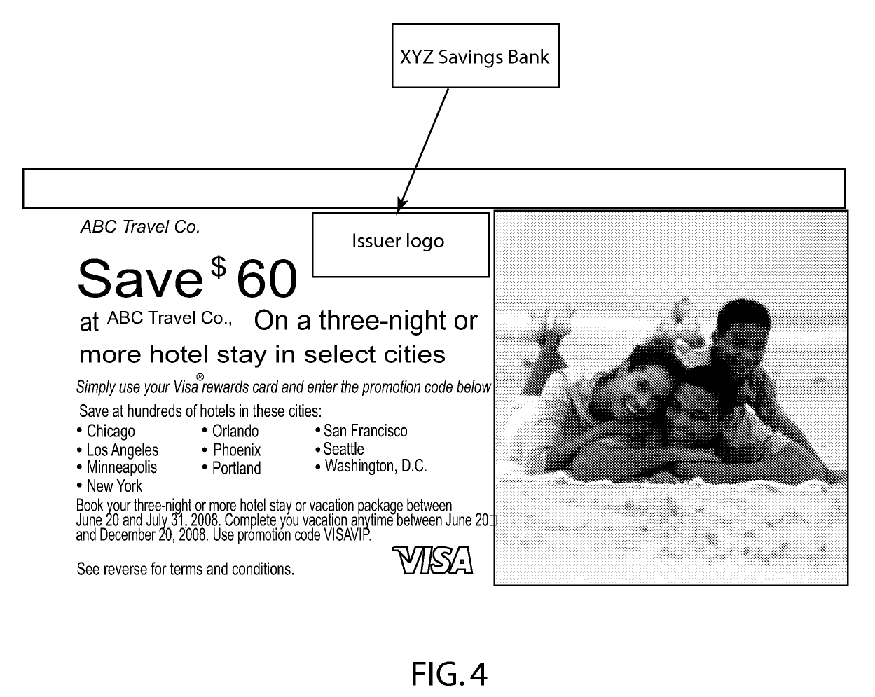

If the offer management module determines from the target database 22 that the “web id available” flag is set and the associated flag indicates that the holder of the account has opted in to receive marketing offers, then step 52 is executed. In step 52, the offer management module determines whether the financial account is a target for receiving the marketing offer (e.g., targeted direct mail campaign marketing offer) by querying the target database 22. If so, in step 54, the management module selects a targeted marketing offer and retrieves an associated marketing offer image from the image database 24 (see FIG. 4, for example).

In one embodiment, the retrieved image contains all of the information for the marketing offer except the identification of an issuer. As part of step 54, the offer management module inserts an appropriate issuer logo into the retrieved image to finalize the offer image and then stores the finalized image (“white labeled”) in its storage to be served to the cardholder's computer 4. The issuer identification can be made, for example, by examining the Bank Identification Number (BIN which comprises the first 6 digits of the card number) of the account identifier.

In another embodiment, the retrieved image contains all of the information for the marketing offer including the identification of an issuer. In this way, the image can be served to the cardholder's computer 4 without any delay in assembling the finalized image.

If the answer in step 52 is NO, that means the account has not been targeted to receive a predetermined targeted marketing offer. In that case, the offer management module in step 56 determines whether the financial account is a premium account, e.g., Visa Signature account (VSIG). If so, in step 58, the management module selects an appropriate marketing offer for the premium account and retrieves the associated offer image from the image database 24. Similar to step 54, the retrieved image can be a complete white-labeled image or an incomplete image which is then combined with an issuer logo image.

If the answer in step 56 is No, the management module in step 60 determines whether the issuer has opted in for participating in a merchant offer program (MOP). MOP is a basic program that contains standard marketing offers that can be offered to any type of cards. If so, in step 62, the offer management module selects an appropriate MOP marketing offer and retrieves the associated offer image from the image database 24. Similar to step 54, the retrieved image can be a complete white-labeled image or an incomplete image which is then combined with an issuer logo image.

If the answer in step 60 is No, that means that the offer management module could not locate any appropriate marketing offer to serve to the cardholder. In that case, step 64 generates a reply message which indicates that no marketing offer was found for the financial account.

On the other hand, if step 64 is executed as a result of step 54, 58 or 62, then the offer management module generates a reply message which contains a location link from which the finalized offer image can be downloaded. One example of a location is “<img src=“http://www.offer-servercom/targeted-offer.jpg”/>”.

Referring back to FIG. 3A, the offer management module of the offer management computer 8 transmits the generated reply message to the issuer computer 6 through the network 10.

In step 46, the account maintenance module of the issuer computer 6 receives the reply message and assembles a webpage with an instruction (e.g., an HTML tag) to download an image located at the location link. However, if the reply message indicates that there is no marketing offer, the account maintenance module may substitute a link to its own marketing offer image when assembling the webpage. The assembled webpage is then transmitted to the cardholder's computer 4 through the network 10.

In step 48, the web browser module running in the cardholder's computer 4 receives the webpage and executes the various HTML tags and applets that are contained in the webpage. As part of the execution, the web browser downloads the finalized offer image (such as shown in FIG. 4) from the location link contained in the webpage and displays the image on the cardholders display while the cardholder/user is in the communication session with the issuer website.

Referring now to FIG. 1, the offer management computer 8 can maintain the entire catalog of marketing offer images on its own website and in the event of the match (when the answer to decision steps 52, 56 or 60 is a yes), it can in real time upload the ‘white label’ and personalized marketing offer image to the respective issuer's web site. This offer image can be displayed to the cardholder through the browser while he is still logged in to the website and is in a communication session.

Alternatively, the issuer computer 6 can maintain its own applicable marketing offer images and target list on its own database such as the issuer database 26 (periodically updated by the offer management computer 8) with its own branding and present them to the cardholder if that cardholder has indicated ‘Opt In’ to marketing messages from their issuer and if they happen to be on the target list for specific offers.

Although the present invention has been discussed with reference to a credit card, persons of ordinary skill in the art will appreciate that the invention can be used with any financial account that can be presented to merchants of goods or services to merchants for payment.

The foregoing specific embodiments represent just some of the ways of practicing the present invention. Many other embodiments are possible within the spirit of the invention. For example, prior to transmitting a message containing the account identifier, the issuer computer can initially check to see if the cardholder has opted in to receiving marketing materials. That means the offer management computer only needs to check whether the account identifier is present in the target database without the need to check for opt-in flag or web-id-available flags. Accordingly, the scope of the invention is not limited to the foregoing specification, but instead is given by the appended claims along with their full range of equivalents.

What is claimed is:

1. A system for providing a marketing offer to holders of financial accounts during a communication session, the system comprising:
a processor;
an account maintenance module executable by the processor and adapted to initiate a communication session with a user computer of an account holder over a computer network, wherein the account maintenance module:
determines whether a financial account associated with the account holder is a target for receiving the marketing offer; and
if so, transmits the marketing offer to the user computer over the computer network during the communication session.

2. The system of claim 1, further comprising a target database adapted to store financial account identifiers identifying financial accounts that have been targeted for receiving the marketing offer.

3. The system of claim 1, wherein, during the communication session, the account maintenance module determines whether the associated financial account has opted in to receiving marketing materials from an issuer of the associated financial account.

4. The system of claim 1, wherein the account maintenance module sends a message containing an account identifier to an offer management computer, the message containing a request to determine whether the financial account identified by the account identifier is in a targeted list for receiving the marketing offer.

5. The system of claim 4, wherein responsive to the sent message, the account maintenance module receives from the offer management computer a message containing a web link to a marketing offer image for download through the Internet.

6. The system of claim 4, wherein responsive to the sent message, the account maintenance module receives from the offer management computer a message containing a web link to a marketing offer image containing a symbol for the issuer of the associated financial account for download through the Internet.

7. The system of claim 4, wherein the offer management computer manages the marketing offer for a plurality of issuers of the financial accounts.

8. A system for providing a marketing offer to holders of financial accounts during a communication session, the system comprising:
a processor;
an offer management module executable by the processor and adapted to communicate with an issuer computer that initiates a communication session with a user computer of an account holder, wherein the offer management module:
receives from the issuer computer a message containing an account identifier identifying a financial account associated with the account holder before the communication session ends;
in response to the received message, determines whether the associated financial account is a target for receiving the marketing offer; and
if so, transmits a message to the issuer computer that the associated financial account is a target for receiving the marketing offer.

9. The system of claim 8, further comprising a target database adapted to store financial account identifiers identifying financial accounts that have been targeted for receiving the marketing offer, wherein the offer management module determines whether the associated financial account is a target for receiving the marketing offer by querying the target database.

10. The system of claim 8, wherein the offer management module transmits the message containing a web link to a marketing offer image for download through the Internet.

11. The system of claim 10, wherein the offer management module transmits the message containing a web link to a marketing offer image containing a symbol for the issuer of the associated financial account for download through the Internet.

12. The system of claim 8, wherein the offer management module determines whether the associated financial account has opted in to receiving marketing materials from an issuer of the associated financial account.

13. The system of claim 8, wherein the offer management module manages the marketing offer for a plurality of issuers of the financial accounts.

14. A system for providing a marketing offer to holders of financial accounts during a communication session, the system comprising:
an issuer computer adapted to initiate a communication session with a user computer of an account holder;
a target database adapted to store financial account identifiers identifying financial accounts that have been targeted for receiving a marketing offer which is available to a plurality of issuers of financial accounts;
an offer management computer coupled to the issuer computer and the target database, and adapted to:
receive from the issuer computer a message containing an account identifier identifying a financial account associated with the holder before the communication session ends;
in response to the received message, query the target database to determine whether the associated financial account is a target for receiving the marketing offer; and
if so, transmit a message to the issuer computer that the associated financial account is a target for receiving the marketing offer.

15. The system of claim 14, wherein the offer management computer transmits the message containing a web link to a marketing offer image for download through the Internet.

16. The system of claim 15, wherein the offer management computer transmits the message containing a web link to a marketing offer image containing a symbol for the issuer of the associated financial account for download through the Internet.

17. The system of claim 14, wherein the offer management computer determines whether the associated financial account has opted in to receiving marketing materials from an issuer of the associated financial account.

18. A method by an issuer computer of providing a marketing offer to holders of financial accounts during a communication session, the method comprising:
interacting, by the issuer computer, with a user computer of an account holder to initiate a communication session;
determining, before the communication session ends, whether a financial account associated with the holder is a target for receiving the marketing offer; and
if so, transmitting, by the issuer computer, the marketing offer to the user computer.

19. The method of claim 18, wherein the step of determining includes querying a target database that stores financial account identifiers identifying financial accounts that have been targeted for receiving the marketing offer.

20. The method of claim 18, further comprising determining whether the associated financial account has opted in to receiving marketing materials from an issuer of the associated financial account.

21. The method of claim 18, wherein the step of determining includes sending a message containing an account identifier to an offer management computer, the message containing a request to determine whether the financial account identified by the account identifier is in a targeted list for receiving the marketing offer.

22. The method of claim 21, wherein the message is sent to the offer management computer that manages the marketing offer for a plurality of issuers of the financial accounts.

23. The method of claim 21, wherein the step of determining includes, responsive to the sent message, receiving from the offer management computer a message containing a web link to a marketing offer image for download through the Internet.

24. The method of claim 23, wherein the received message contains a web link to a marketing offer image containing a symbol for the issuer of the associated financial account for download through the Internet.

25. A computer readable storage medium containing software code which, when executed by a processor, performs the method of claim 18.

26. A method by an offer management computer of providing a marketing offer to holders of financial accounts during a communication session, the method comprising:
receiving by the offer management computer a message from an issuer computer that has initiated a communication session with a user computer of an account holder, the message being received before the communication session ends and containing an account identifier identifying a financial account associated with the holder;
in response to the received message, determining by the offer management computer whether the associated financial account is a target for receiving the marketing offer; and
if so, transmitting a message to the issuer computer that the associated financial account is a target for receiving the marketing offer.

27. The method of claim 26, wherein the step of determining includes querying a target database that stores financial account identifiers identifying financial accounts that have been targeted for receiving the marketing offer.

28. The method of claim 26, further comprising determining whether the associated financial account has opted in to receiving marketing materials from an issuer of the associated financial account.

29. The method of claim 26, wherein the offer management manages the marketing offer for a plurality of issuers of the financial accounts.

30. The method of claim 26, wherein the step of transmitting includes transmitting a message containing a web link to a marketing offer image for download through the Internet.

31. The method of claim 30, wherein the message contains a web link to a marketing offer image containing a symbol for the issuer of the associated financial account for download through the Internet.

32. A computer readable storage medium containing software code which, when executed by a processor, performs the method of claim 26.
